(19) United States
(12) Patent Application Publication
(10) Pub. No.: US 2025/0274870 A1
(43) Pub. Date: Aug. 28, 2025

(54) MULTI-CELL UPLINK WAKEUP SIGNAL CONFIGURATION

(71) Applicant: QUALCOMM Incorporated, San Diego, CA (US)

(72) Inventors: Navid ABEDINI, Basking Ridge, NJ (US); Naeem AKL, San Jose, CA (US); Peter GAAL, San Diego, CA (US)

(21) Appl. No.: 19/062,212

(22) Filed: Feb. 25, 2025

Related U.S. Application Data
(60) Provisional application No. 63/557,877, filed on Feb. 26, 2024.

(51) Int. Cl. H04W 52/02; H04W 84/04

(52) U.S. Cl. CPC H04W 52/0235; H04W 52/0219; H04W 84/042

(57) ABSTRACT

Various aspects of the present disclosure generally relate to wireless communication. In some aspects, a user equipment (UE) may receive an uplink wakeup signal (UL-WUS) configuration associated with multiple cells, wherein the UL-WUS configuration indicates resources associated with one or more UL-WUS occasions associated with the multiple cells. The UE may identify a cell, of the multiple cells, to which a UL-WUS is to be transmitted. The UE may identify a valid UL-WUS occasion, of the one or more UL-WUS occasions, for transmitting the UL-WUS to the cell based at least in part on the UL-WUS configuration. The UE may transmit, to the cell, the UL-WUS using resources associated with the valid UL-WUS occasion. Numerous other aspects are described.

### CROSS-REFERENCE TO RELATED APPLICATION

This patent application claims priority to U.S. Provisional Patent Application No. 63/557,877, filed on Feb. 26, 2024, entitled “MULTI-CELL UPLINK WAKEUP SIGNAL CONFIGURATION,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods for a multi-cell uplink wakeup signal configuration.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving an uplink wakeup signal (UL-WUS) configuration associated with multiple cells, wherein the UL-WUS configuration indicates resources associated with one or more UL-WUS occasions associated with the multiple cells. The method may include identifying a cell, of the multiple cells, to which a UL-WUS is to be transmitted. The method may include identifying a valid UL-WUS occasion, of the one or more UL-WUS occasions, for transmitting the UL-WUS to the cell based at least in part on the UL-WUS configuration. The method may include transmitting, to the cell, the UL-WUS using resources associated with the valid UL-WUS occasion.

Some aspects described herein relate to a method of wireless communication performed by a network node. The method may include receiving, from a UE and in resources associated with a valid UL-WUS occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node. The method may include transmitting, to the UE, a system information block (SIB) based at least in part on receiving the UL-WUS.

Some aspects described herein relate to a UE for wireless communication. The UE may include one or more memories and one or more processors coupled to the one or more memories. The one or more processors may be configured, individually or in any combination, to receive a UL-WUS configuration associated with multiple cells, wherein the UL-WUS configuration indicates resources associated with one or more UL-WUS occasions associated with the multiple cells. The one or more processors may be configured, individually or in any combination, to identify a cell, of the multiple cells, to which a UL-WUS is to be transmitted. The one or more processors may be configured, individually or in any combination, to identify a valid UL-WUS occasion, of the one or more UL-WUS occasions, for transmitting the UL-WUS to the cell based at least in part on the UL-WUS configuration. The one or more processors may be configured, individually or in any combination, to transmit, to the cell, the UL-WUS using resources associated with the valid UL-WUS occasion.

Some aspects described herein relate to a network node for wireless communication. The network node may include one or more memories and one or more processors coupled to the one or more memories. The one or more processors may be configured, individually or in any combination, to receive, from a UE and in resources associated with a valid UL-WUS occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node. The one or more processors may be configured, individually or in any combination, to transmit, to the UE, a SIB based at least in part on receiving the UL-WUS.

Some aspects described herein relate to a non-transitory computer-readable medium that stores a set of instructions for wireless communication by a UE. The set of instructions, when executed by one or more processors of the UE, may cause the UE to receive a UL-WUS configuration associated with multiple cells, wherein the UL-WUS configuration indicates resources associated with one or more UL-WUS occasions associated with the multiple cells. The set of instructions, when executed by one or more processors of the UE, may cause the UE to identify a cell, of the multiple cells, to which a UL-WUS is to be transmitted. The set of instructions, when executed by one or more processors of the UE, may cause the UE to identify a valid UL-WUS occasion, of the one or more UL-WUS occasions, for transmitting the UL-WUS to the cell based at least in part on the UL-WUS configuration. The set of instructions, when executed by one or more processors of the UE, may cause the UE to transmit, to the cell, the UL-WUS using resources associated with the valid UL-WUS occasion.

Some aspects described herein relate to a non-transitory computer-readable medium that stores a set of instructions for wireless communication by a network node. The set of instructions, when executed by one or more processors of the network node, may cause the network node to receive, from a UE and in resources associated with a valid UL-WUS occasion, a UL-WUS, wherein the UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node. The set of instructions, when executed by one or more processors of the network node, may cause the network node to transmit, to the UE, a SIB based at least in part on receiving the UL-WUS.

Some aspects described herein relate to an apparatus for wireless communication. The apparatus may include means for receiving a UL-WUS configuration associated with multiple cells, wherein the UL-WUS configuration indicates resources associated with one or more UL-WUS occasions associated with the multiple cells. The apparatus may include means for identifying a cell, of the multiple cells, to which a UL-WUS is to be transmitted. The apparatus may include means for identifying a valid UL-WUS occasion, of the one or more UL-WUS occasions, for transmitting the UL-WUS to the cell based at least in part on the UL-WUS configuration. The apparatus may include means for transmitting, to the cell, the UL-WUS using resources associated with the valid UL-WUS occasion.

Some aspects described herein relate to an apparatus for wireless communication. The apparatus may include means for receiving, from a UE and in resources associated with a valid UL-WUS occasion, a UL-WUS, wherein the UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the apparatus. The apparatus may include means for transmitting, to the UE, a SIB based at least in part on receiving the UL-WUS.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a synchronization signal hierarchy, in accordance with the present disclosure.

FIGS. 5A-5B are diagrams illustrating examples associated with cell discontinuous transmission and/or discontinuous reception, in accordance with the present disclosure.

FIGS. 6A-6B is a diagram of an example associated with a multi-cell uplink wakeup signal configuration, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, network entities (e.g., user equipments (UEs), network nodes, and/or similar components) may be capable of exchanging wakeup signals (WUSs), such as for a purpose of alerting another network entity to wake up from a low-power state in order to transmit an on-demand signal and/or to receive a communication. For example, a UE may be configured with one or more uplink-WUS (UL-WUS) occasions, which may correspond to resources to be used for transmitting one or more UL-WUSs to a cell (sometimes referred to herein as a network energy savings (NES) cell) in order to request that an on-demand system information block (SIB) (e.g., SIB1) be transmitted by the NES cell. In such examples, the UE may be provided with a UL-WUS configuration, which may include information used to transmit a request for an on-demand SIB1, information used to acquire SIB1, and/or similar information.

In some examples, a UL-WUS configuration may be transmitted to the UE by an anchor cell, which may be a cell located in a vicinity of an NES cell and that is separate from the NES cell for which the UL-WUS configuration applies. More particularly, the anchor cell may provide UL-WUS configuration information for a particular NES cell to the UE such that the UE may transmit communications (e.g., UL-WUSs, among other examples) to the NES cell in order to wake up the NES cell and thus receive a communication therefrom (e.g., SIB1 or a similar communication). In some examples, the UL-WUS configuration may indicate periods of time (sometimes referred to as UL-WUS occasions) during which the NES cell may wake up and transmit one or more synchronization signal blocks (SSBs) and/or monitor for one or more UL-WUSs from one or more UEs. Based at least in part on the UL-WUS configuration received from the anchor cell, the UE may transmit a UL-WUS to the NES cell, such as for a purpose of requesting an on-demand SIB (e.g., SIB1). Accordingly, in response to receiving the UL-WUS, the NES cell may wake up from a sleep state or other power-saving state in order to transmit the requested communication (e.g., SIB1).

In some cases, multiple NES cells may be in a vicinity of an anchor cell and/or an anchor cell may service multiple NES cells (e.g., provide UL-WUS configurations for multiple NES cells). In such cases, it may be overly burdensome for the anchor cell to provide the numerous UL-WUS configurations (e.g., on-demand SIB1 configurations) for each NES cell. On the other hand, for a UE that detects multiple NES cells in a given area, it may be overly burdensome for the UE to acquire, store, and keep track of the multiple UL-WUS configurations corresponding to the multiple NES cells, particularly in instances in which the UE may be required to request the UL-WUS configurations (e.g., in instances in which the UE is required to request the UL-WUS configurations on-demand from the anchor cell) and/or in situations of a relatively mobile UE in which the UE needs to constantly acquire UL-WUS configuration information from new anchor cells. Accordingly, such situations may result in high signaling overhead, crowded communication channels associated with high latency and low bandwidth, high power consumption at the cells and/or UEs, and otherwise inefficient usage of power, computing, and network resources.

Various aspects relate generally to multi-cell UL-WUS configurations. Some aspects more specifically relate to UL-WUS configurations that apply to multiple cells, such as multiple NES cells within a vicinity of an anchor cell. In some aspects, an anchor cell may provide, to a UE, a UL-WUS configuration that is to be used for all NES cells within a given geographical area (e.g., identified using an area identifier), for all NES cells within a given zone (e.g., identified using a zone identifier), for all NES cells within a given tracking area (e.g., identified using a tracking area identifier), for all NES cells within a given radio access network (RAN) notification area (RNA) (e.g., identified using a RNA identifier), and/or for all NES cells indicated by the anchor cell (e.g., via an NES cell list provided with the UL-WUS configuration). Accordingly, when the UE is to send a UL-WUS to one of the NES cells, the UE may use the common UL-WUS configuration, such as by selecting and/or validating a UL-WUS occasion indicated by the common UL-WUS configuration (e.g., ensuring that the occasion does not overlap with a downlink slot for the given NES cell, ensuring that the occasion does not overlap with a transmitted SSB by the given NES cell, and/or a performing a similar validation process for the given NES cell).

Particular aspects of the subject matter described in this disclosure can be implemented to realize one or more of the following potential advantages. In some examples, by providing a common UL-WUS configuration for multiple cells, the described techniques can be used to reduced signaling overhead associated with UL-WUS procedures, thereby freeing up communication channels and thus resulting in reduced latency and higher bandwidth. In some other examples, by providing a common UL-WUS configuration for multiple cells, power consumption associated with an anchor cell providing numerous individual UL-WUS configurations and/or with a UE requesting and/or storing numerous individual UL-WUS configurations may be reduced, thereby resulting in more efficient usage of power, computing, and network resources.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

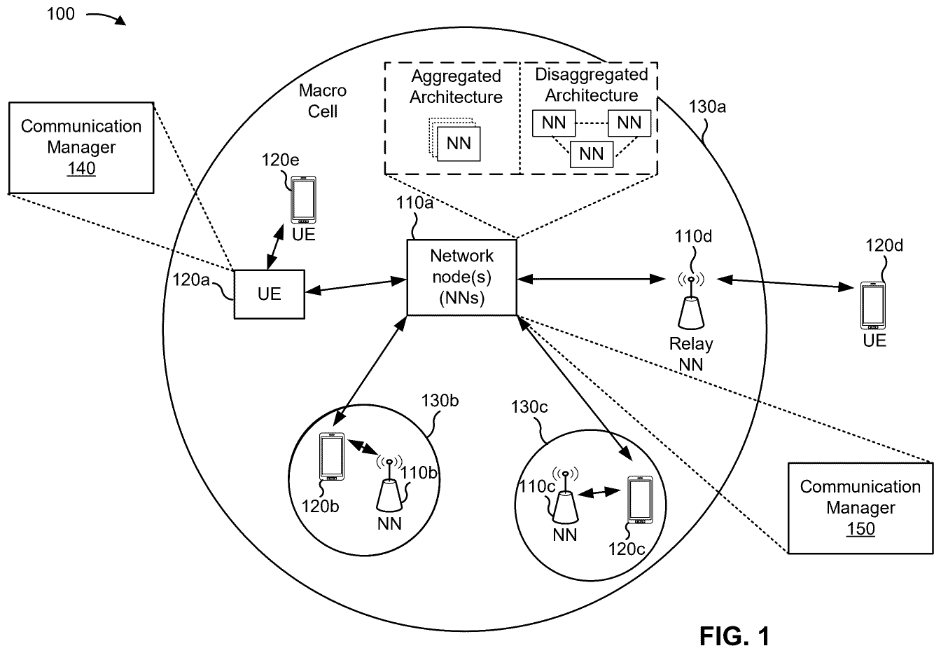

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHz), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHZ), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FRI or FR2 into mid-band frequencies. Thus, “sub-6 GHZ,” if used herein, may broadly refer to frequencies that are less than 6 GHZ, that are within FRI, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FRI, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a RAN.

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in a UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit a UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive a UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a UL-WUS configuration associated with multiple cells, wherein the UL-WUS configuration indicates resources associated with one or more UL-WUS occasions associated with the multiple cells; identify a cell, of the multiple cells, to which a UL-WUS is to be transmitted; identify a valid UL-WUS occasion, of the one or more UL-WUS occasions, for transmitting the UL-WUS to the cell based at least in part on the UL-WUS configuration; and transmit, to the cell, the UL-WUS using resources associated with the valid UL-WUS occasion. Additionally, or alternatively, the communication manager 140 may perform one or more other operations described herein.

In some aspects, the network node 110 may include a communication manager 150. As described in more detail elsewhere herein, the communication manager 150 may receive, from a UE and in resources associated with a valid UL-WUS occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node; and transmit, to the UE, a SIB based at least in part on receiving the UL-WUS. Additionally, or alternatively, the communication manager 150 may perform one or more other operations described herein.

As indicated above, FIG. 1 is provided as an example. Other examples may differ from what is described with regard to FIG. 1.

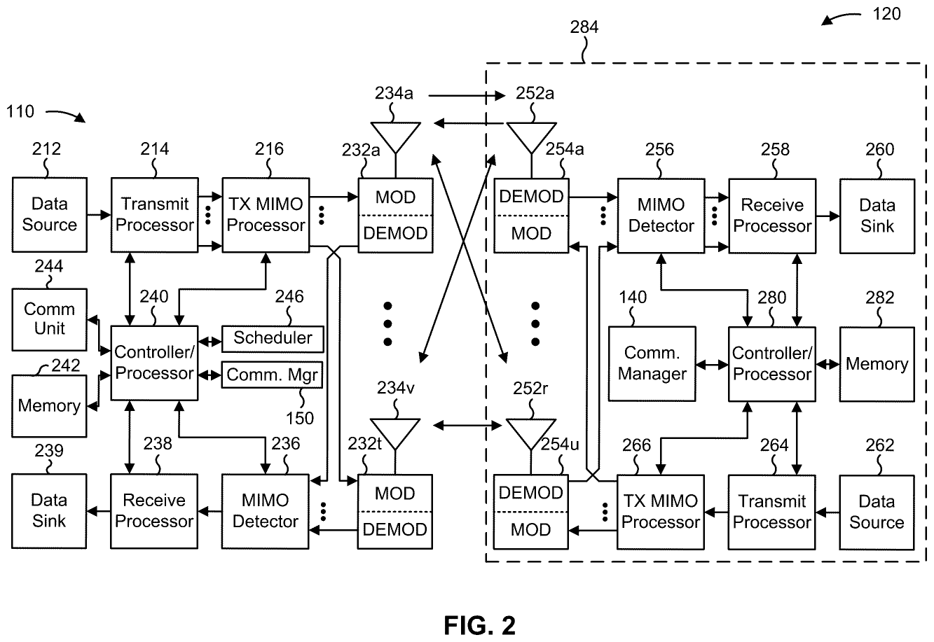

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

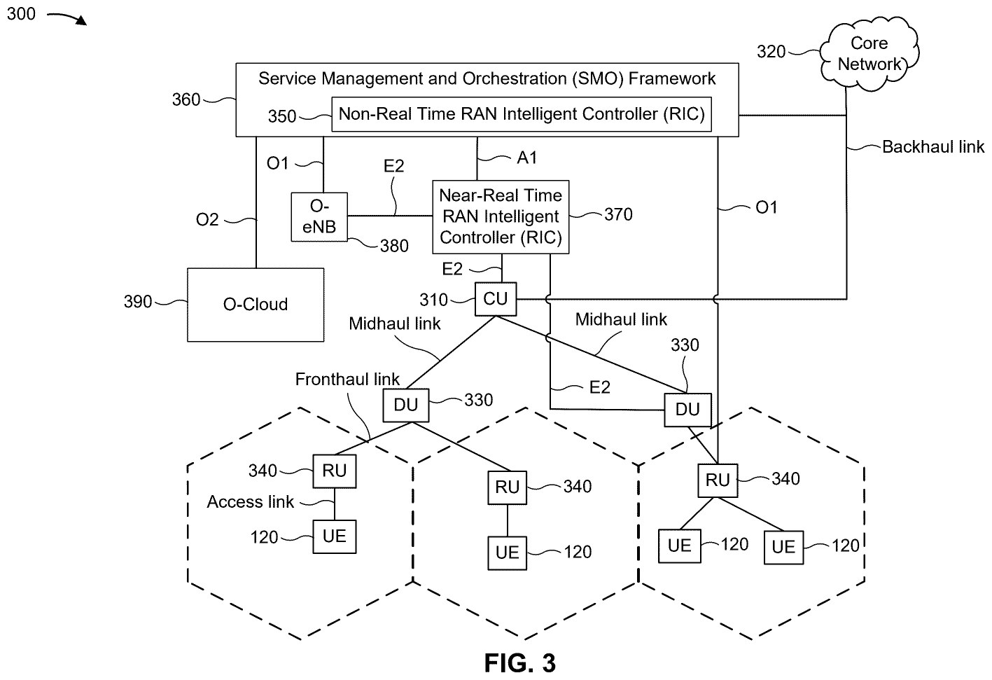

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

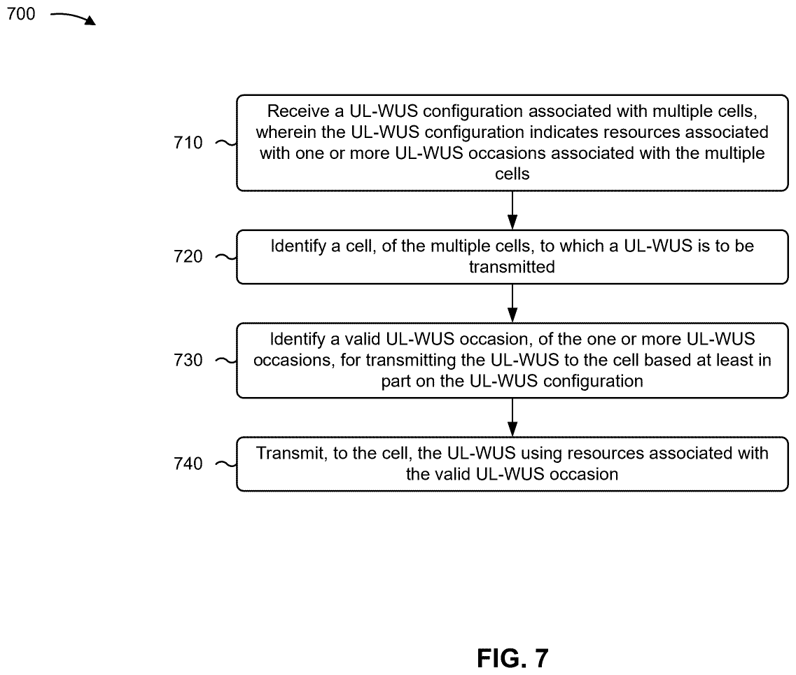

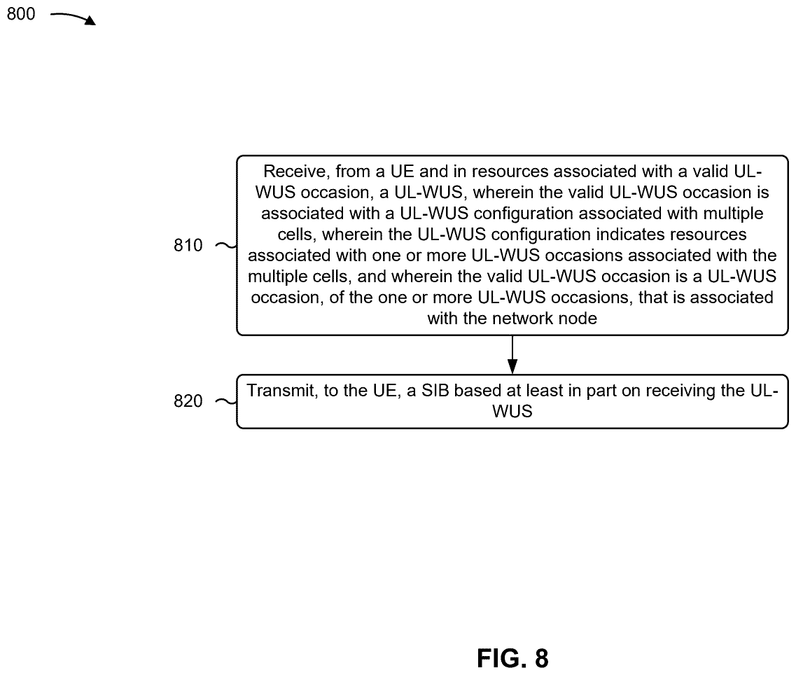

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a multi-cell UL-WUS configuration, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the UE 120 includes means for receiving a UL-WUS configuration associated with multiple cells, wherein the UL-WUS configuration indicates resources associated with one or more UL-WUS occasions associated with the multiple cells; means for identifying a cell, of the multiple cells, to which a UL-WUS is to be transmitted; means for identifying a valid UL-WUS occasion, of the one or more UL-WUS occasions, for transmitting the UL-WUS to the cell based at least in part on the UL-WUS configuration; and/or means for transmitting, to the cell, the UL-WUS using resources associated with the valid UL-WUS occasion. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE and in resources associated with a valid UL-WUS occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node; and/or means for transmitting, to the UE, a SIB based at least in part on receiving the UL-WUS. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

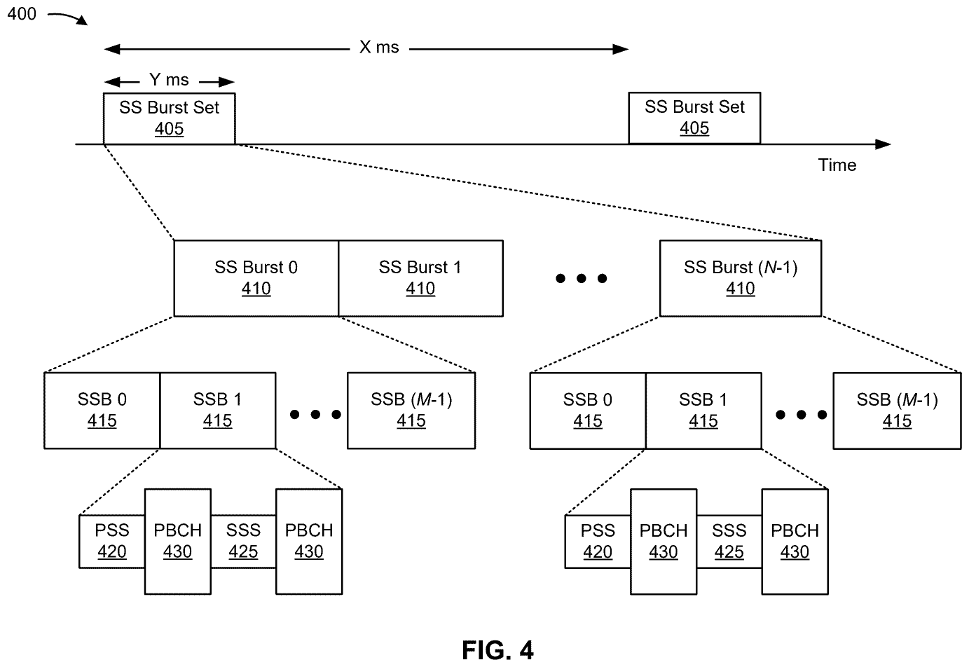

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SSBs 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a PSS 420, an SSS 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., an RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

In some examples, a network node 110 may be associated with a massive-MIMO active antenna unit (AAU) to receive and/or to transmit signals, such as a massive-MIMO AAU that includes multiple, co-located panels consisting of multiple antenna ports. Each panel may be equipped with numerous power amplifiers and antenna subsystems, which consume large amounts of power. For example, more than 20% of all expenses associated with a wireless network may be attributed to energy costs necessary to operate the wireless network and, of those energy costs, over 50% may be attributed to RAN energy costs. Thus, network energy savings may be important for adoption and expansion of cellular networks.

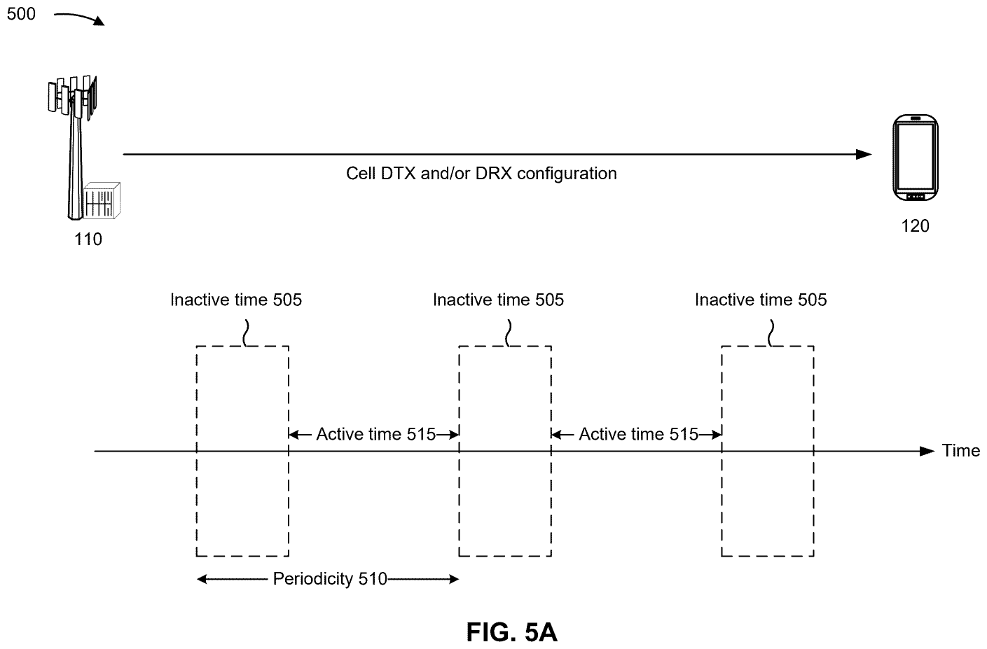

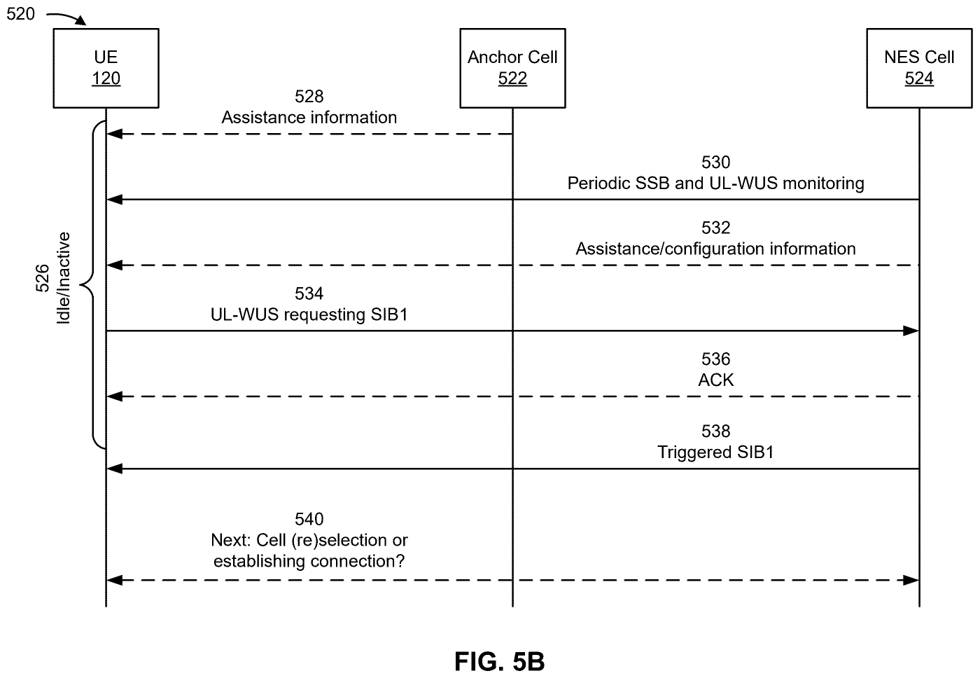

In some examples, in order to reduce energy consumption by network components (e.g., network nodes 110 and/or other components) and/or for a similar purpose, a network node 110 may be configured to power down during periods of low load, such as by operating in a discontinuous transmission (DTX) mode and/or a discontinuous reception (DRX) mode, sometimes referred to as cell DTX and/or cell DRX, respectively. In some aspects, a network node 110 that is capable of operating in a DTX mode and/or DRX mode and/or that is other capable of operating in reduced power mode may be referred to as an NES network node and/or a cell associated with an NES network node may be referred to as an NES cell. Aspects of cell DTX, cell DRX, and/or NES cells are described in more detail below in connection with FIGS. 5A-5B.

As indicated above, FIG. 4 is provided as an example. Other examples may differ from what is described with regard to FIG. 4.

FIGS. 5A-5B are diagrams illustrating examples associated with cell DTX and/or DRX, in accordance with the present disclosure. As shown in FIG. 5A, an example 500 includes a UE 120 in communication with a network node 110. In some examples, the UE 120 may be in a connected state (e.g., an RRC connected state) with the network node 110.

As shown, the network node 110 may transmit a cell DTX and/or DRX configuration to the UE 120 to configure a cell DTX and/or DRX cycle for the UE 120. For example, the configuration may be for cell DTX, cell DRX, or both cell DTX and cell DRX. The configuration may indicate an inactive time 505 (which may also be referred to as an “uplink and/or downlink channel restriction window”) for the cycle. The configuration may indicate a starting time of the inactive time 505 (e.g., a time offset), a duration of the inactive time 505, and/or a periodicity 510 of the inactive time 505, among other examples. One or more types of physical channels or signals may be restricted during the inactive time 505 (e.g., a restricted channel or signal that is scheduled or configured during the inactive time 505 may be dropped by the network node 110 and/or the UE 120). That is, the UE 120 may be expected to not transmit or receive particular channels or signals during the inactive time 505. In this way, the network node 110 may enter a sleep state during the inactive time 505. Downlink channels or signals restricted during the inactive time 505 may include periodic and/or semi-persistent CSI-RSs (e.g., including tracking reference signals (TRSs)), positioning reference signals (PRSs), PDCCHs scrambled with a UE-specific radio network temporary identifier (RNTI), PDCCHs in a type-3 common search space (CSS) (e.g., a group-common PDCCH), and/or SPS PDSCHs, among other examples. Additionally, or alternatively, uplink channels or signals restricted during the inactive time 505 may include scheduling requests, periodic and/or semi-persistent CSI reports, periodic and/or semi-persistent SRSs, and/or CG PUSCHs, among other examples. As further shown, cell DTX and/or DRX may include active times 515 outside of (e.g., between) inactive times 505. Physical channel or signal restrictions applicable to the inactive time 505 may not be applicable to the active time 515.

In some examples, during the inactive time 505, the UE 120 may be expected to drop physical channels or signals associated with a minimal impact to UE implementation complexity or system performance. For example, in downlink, the UE 120 may drop reception of a PDCCH in a type-3 CSS, an SPS communication, a CSI-RS for generating CSI, and/or a CSI-RS for propagation delay compensation, among other examples. Additionally, or alternatively, in uplink, the UE 120 may drop transmission of a scheduling request, a CG communication, and/or CSI feedback, among other examples. However, during the inactive time 505, the UE 120 may not be expected to drop physical channels or signals associated with a high impact to UE implementation complexity or system performance. For example, in downlink, the UE 120 may receive a CSI-RS for tracking (e.g., a TRS), a CSI-RS for positioning, a CSI-RS for beam management, and/or a CSI-RS for beam failure detection, among other examples. Additionally, or alternatively, in uplink, the UE 120 may transmit an SRS for positioning and/or a scheduling request, among other examples.

In some examples, in addition to configuring the UE 120 with a cell DTX and/or DRX configuration, the network node 110 and/or the UE 120 may reduce a frequency at which one or more reference signals are exchanged, such as for a purpose of reducing power consumption at the network. For example, in some deployments of a wireless communication standard (e.g., some deployments of a standard promulgated by the 3GPP) and/or for some frequency ranges (e.g., FRI and FR2), intra-band carrier aggregation (CA) with SSB-less carriers may be supported, while, in some other deployments and/or frequency ranges (e.g., FR1), inter-band CA with SSB-less carriers may be supported. Additionally, or alternatively, a UE 120 may be configured to request and/or receive a DRS and/or an on-demand SSB, such as for a purpose of performing synchronization and/or radio resource management (RRM) measurement tasks with reduced signaling. A DRS may be a simplified SSB used for a purpose of radio RRM measurement. An on-demand SSB may be an SSB that is transmitted by the network node 110 in response to a request from the UE 120 and/or an SSB that is used for time and/or frequency synchronization and multi-beam operation. In some examples, a DRS and/or an on-demand SSB may be used for scenarios in which CA with SSB-less carriers is not feasible and/or to extend inter-band CA with SSB-less carriers to certain frequency ranges (e.g., FR2).

Additionally, or alternatively, a UE 120 may be configured with one or more UL-WUS occasions, which may correspond to resources to be used for transmitting one or more UL-WUSs to an NES cell in order to request an on-demand SIB (e.g., SIB1) and/or other communications to be transmitted by the NES cell. In such examples, the UE 120 may be provided with a UL-WUS configuration, which may include configuration information used to transmit a request for an on-demand SIB1, configuration information used to acquire SIB1, and/or similar configuration information.

For example, as shown in FIG. 5B, and as indicated by reference number 520, a UL-WUS configuration may be transmitted to the UE 120 by an anchor cell 522 (e.g., a cell separate from the cell for which the UL-WUS configuration applies), by an NES cell 524 (e.g., the cell for which the UL-WUS configuration applies), or both by the anchor cell 522 and the NES cell 524. More particularly, as indicated by reference number 526, the NES cell 524 may be configured to enter an idle and/or inactive mode (e.g., DTX inactive mode, a DRX inactive mode, and/or a similar low-power mode), such as for a purpose of reducing power consumption at the NES cell 524. Accordingly, in some cases, another cell separate from the NES cell 524, sometimes referred to as an anchor cell (e.g., the anchor cell 522), may provide UL-WUS configuration information to the UE 120 such that the UE 120 may transmit communications (e.g., UL-WUSs, among other examples) to the NES cell 524 in order to wake up the NES cell 524 and thus receive a communication therefrom (e.g., SIB1 or a similar communication). In such cases, the anchor cell 522 may transmit, and the UE 120 may receive, assistance information that indicates the UL-WUS configuration, as indicated by reference number 528. In some cases, using an anchor cell (e.g., anchor cell 522) to provide a UL-WUS configuration to a UE may enable more flexible UL-WUS configuration and/or UL-WUS indications, because it may be difficult for an NES cell (e.g., the NES cell 524) to indicate UL-WUS configurations to inactive and/or idle UEs, among other reasons.

In some examples, the UL-WUS configuration may indicate periods of time (e.g., UL-WUS occasions) during which the NES cell 524 may wake up and transmit one or more SSBs and/or monitor for one or more UL-WUSs from one or more UEs. For example, as indicated by reference number 530, the NES cell 524 may periodically transmit SSBs and/or monitor for UL-WUSs. Additionally, or alternatively, as indicated by reference number 532, in some cases the NES cell 524 may transmit, and the UE 120 may receive, assistance information and/or configuration information, such as information indicating the UL-WUS configuration for the NES cell 524. Put another way, in some examples the NES cell 524 itself may provide the UL-WUS configuration to the UE 120. In some examples, providing the UL-WUS configuration via an NES cell (e.g., NES cell 524) may enable more flexible UL-WUS deployment, because the NES cell may operate in an unanchored environment.

In some examples, both an anchor cell (e.g., anchor cell 522) and an NES cell (e.g., NES cell 524) may provide a UL-WUS configuration to one or more UEs. For example, the anchor cell may provide the UL-WUS configuration (e.g., via the communication described above in connection with reference number 528) for UEs visiting the NES cell and/or selecting the NES cell for the first time. Additionally, or alternatively, the NES cell may provide the UL-WUS configuration (e.g., via the communication described above in connection with reference number 532) when releasing and/or a suspending a connection to a UE. In some examples, such as examples in which camping on an NES cell (e.g., the NES cell 524) is allowed, the NES cell may also broadcast the UL-WUS configuration and/or the NES cell may support update information (e.g., via a short message).

Based at least in part on the UL-WUS configuration received from the anchor cell 522 and/or the NES cell 524, the UE 120 may transmit a UL-WUS to the NES cell (as shown by reference number 534), such as for a purpose of requesting an on-demand SIB (e.g., SIB1). In some cases, as shown by reference number 536, the NES cell 524 may acknowledge (ACK), or, alternatively, negatively acknowledge (NACK), the UL-WUS. Moreover, based at least in part on receiving the UL-WUS, the NES cell 524 may wakeup from a sleep state or other power-saving state, in order to transmit the requested communication (e.g., SIB1), as shown by reference number 538. Based at least in part SIB1, SSBs transmitted by the NES cell 524, and/or other signaling exchanged between the UE 120 and the NES cell 524, the NES cell 524 and/or the UE 120 may perform a cell selection procedure, a cell reselection procedure, a connection establishment procedure, and/or a similar procedure, as shown in connection with reference number 540.

In some cases, multiple NES cells may be in a vicinity of an anchor cell and/or an anchor cell may service multiple NES cells (e.g., an anchor cell may provide UL-WUS configurations for multiple NES cells). In such cases, it may be overly burdensome for the anchor cell to provide the numerous UL-WUS configurations (e.g., on-demand SIB1 configurations) for each NES cell to each UE within a vicinity of the anchor cell. On the other hand, for an UE that detects multiple NES cells in a given area, it may be overly burdensome for the UE to acquire, store, and keep track of the multiple UL-WUS configurations corresponding to the multiple NES cells, particularly in instances in which the UE may be required to request the UL-WUS configurations (e.g., in instances in which the UE is required to request the UL-WUS configurations on-demand from the anchor cell) and/or in situations of a relatively mobile UE, leading to the UE moving around and frequently changing anchor cells. Accordingly, such situations may result in high signaling overhead, crowded communication channels, high latency and low bandwidth, high power consumption at the cells and/or the UEs, and otherwise inefficient usage of power, computing, and network resources.

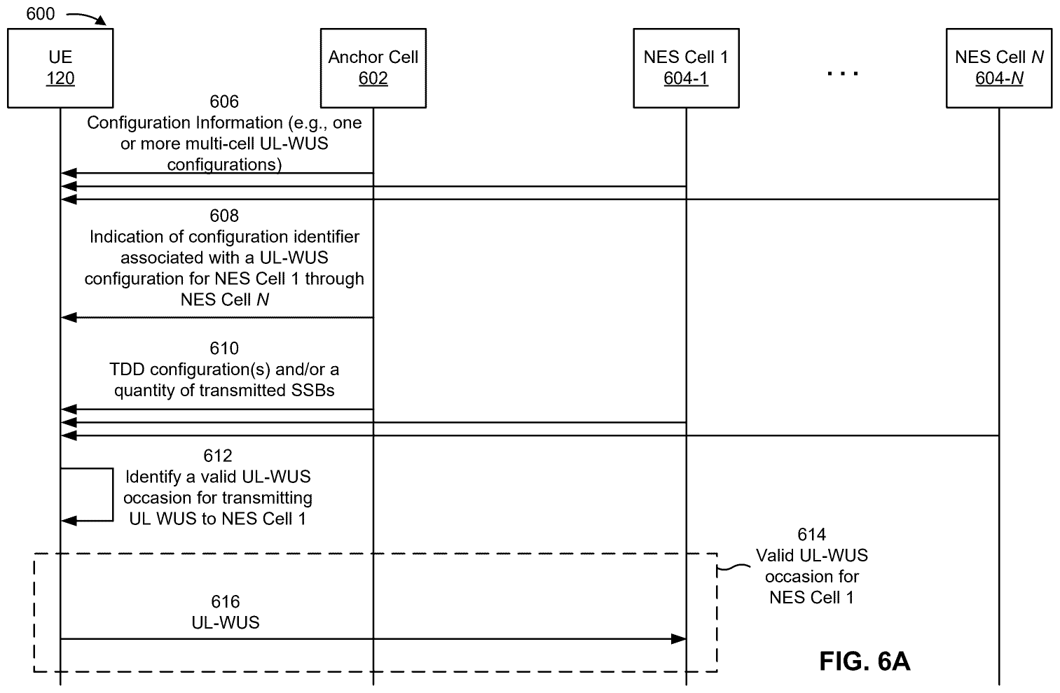

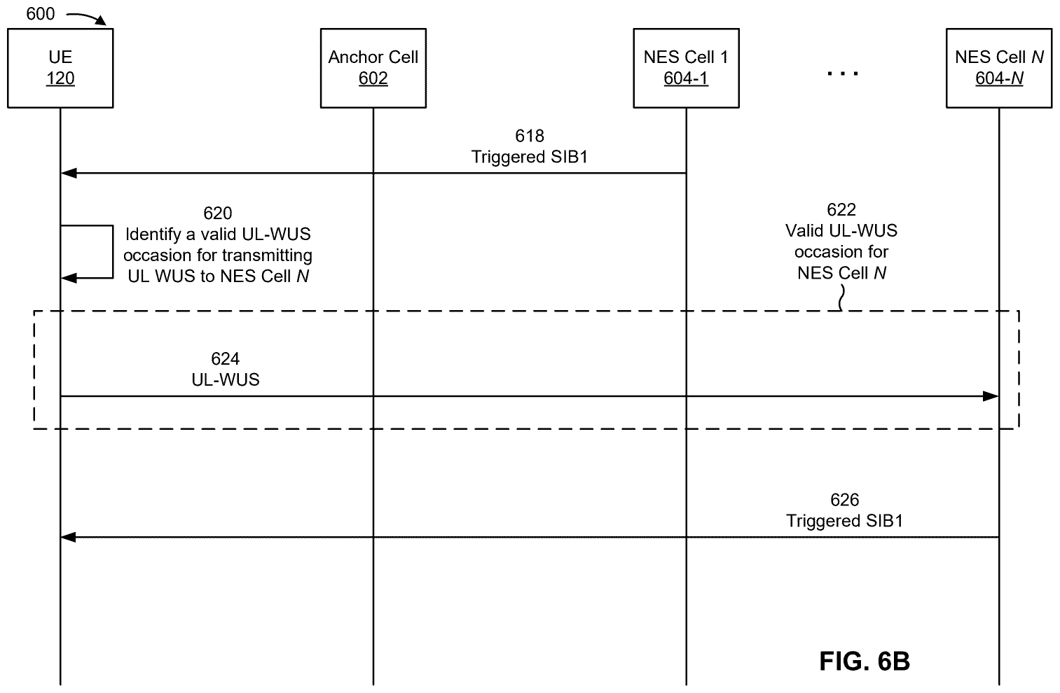

Some techniques and aspects described herein enable a common UL-WUS configuration for multiple cells, such as multiple NES cells within a vicinity of an anchor cell. For example, in some aspects, an anchor cell may provide, to a UE, a UL-WUS configuration that is to be used for all NES cells within a given geographical area (e.g., identified using an area identifier), for all NES cells within a given zone (e.g., identified using a zone identifier), for all NES cells within a given tracking area (e.g., identified using a tracking area identifier), for all NES cells within a given RNA (e.g., identified using a RNA identifier), and/or for all NES cells indicated by the anchor cell (e.g., via an NES cell list provided with the UL-WUS configuration). Accordingly, when the UE is to send a UL-WUS to one of the NES cells, the UE may use the common UL-WUS configuration, such as by selecting and/or validating a UL-WUS occasion indicated by the common UL-WUS configuration (e.g., ensuring that the occasion does not overlap with a downlink slot for the given NES cell, ensuring that the occasion does not overlap with a transmitted SSB by the given NES cell, and/or a performing a similar validation process for the given NES cell). As a result, signaling overhead associated with UL-WUS procedures may be reduced, communication channels between the anchor cell and/or NES cells and UEs may be less crowded resulting in lower latency and higher bandwidth, power consumption at the anchor cell and/or the UE may be reduced, and the UEs, anchor cell, and/or NES cells may otherwise communicate with more efficient usage of power, computing, and network resources. Aspects of a common UL-WUS configuration and/or a UL-WUS configuration that is associated with multiple cells (e.g., multiple NES cells) are described more detail below in connection with FIGS. 6A-6B.

FIGS. 6A-6B are diagrams of an example 600 associated with a multi-cell UL-WUS configuration, in accordance with the present disclosure. As shown in FIGS. 6A-6B, a UE (e.g., UE 120) may communicate with one or more network nodes (e.g., network nodes 110, CUs, DUs, and/or RUs). For example, the UE 120 May communicate with a first network node associated with an anchor cell 602 and/or one or more network nodes associated with one or more NES cells 604 (shown in FIGS. 6A-6B as a first NES cell 604-1 through an N-th NES cell 604-N). In some aspects, the UE 120 and the one or more network nodes may be part of a wireless network (e.g., wireless communication network 100). The UE 120 and one or more of the network nodes may have established a wireless connection prior to operations shown in FIGS. 6A-6B. In some aspects, one or more of the network nodes may support cell DTX and/or cell DRX, and/or may be capable of receiving a UL-WUS, such as for a purpose of entering a cell DTX active state for transmitting communications to the UE (e.g., for transmitting an on-demand SIB1). For example, the NES cells 604 may be capable of supporting cell DTX and/or cell DRX, and/or may be capable of receiving a UL-WUS.

As shown by reference number 606, one or more of the network nodes may transmit, and the UE 120 may receive, configuration information. For example, in a similar manner as described above in connection with reference numbers 528 and 532, the anchor cell 602 and/or one or more of the NES cells 604 may transmit, and the UE 120 may receive, configuration information. In some aspects, the UE 120 may receive the configuration information via one or more of system information (e.g., a master information block (MIB) and/or a SIB, among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein, such as the indication described below in connection with reference number 608) may include a dynamic indication, such as one or more MAC-CEs and/or one or more DCI messages, among other examples.

In some aspects, the configuration information may indicate a UL-WUS configuration that is associated with multiple cells (sometimes referred to herein as a multiple cell UL-WUS configuration, or, more simply, a multi-cell UL-WUS configuration), such as a UL-WUS configuration associated with the first NES cell 604-1 through the N-th NES cell 604-N. In some aspects, the UL-WUS configuration May include configuration information for the UE 120 to demand SIB1 from the multiple cells (e.g., the first NES cell 604-1 through the N-th NES cell 604-N) and/or configuration information for the UE 120 to acquire the demanded SIB1 from the multiple cells. Additionally, or alternatively, the UL-WUS configuration may indicate resources associated with one or more UL-WUS occasions associated with the multiple cells (e.g., resources that may be used by the UE 120 to transmit a UL-WUS to an NES cell 604 and/or resources that may be monitored by one or more NES cells 604 for receiving a UL-WUS).

In some aspects, the multi-cell UL-WUS configuration may indicate which NES cells 604 are associated with the multi-cell UL-WUS configuration (e.g., which NES cells 604 may be communicated with using a UL-WUS transmitted according to the UL-WUS configuration). For example, in some aspects, the multi-cell UL-WUS configuration may be defined in an area-specific manner, such as by using a framework associated with a system information area identifier (ID) (sometimes referred to as systemInformationAreaID). For example, the UL-WUS configuration may indicate an area ID, and thus the UL-WUS configuration may be used for any NES cell 604 associated with the same area ID (e.g., as indicated by a systemInformationAreaID associated with the NES cell 604). Additionally, or alternatively, in aspects involving an area ID, the anchor cell 602 may or may not belong to the area ID that is associated with the multi-cell UL-WUS configuration (e.g., the anchor cell 602 may be capable of providing multi-cell UL-WUS configurations for multiple areas). Put another way, when the configuration information (e.g., the multi-cell UL-WUS configuration) is received by the UE 120 from the anchor cell 602, in some aspects the anchor cell 602 may associated with a same area ID (e.g., systemInformationAreaID) as an area ID of the multi-cell UL-WUS configuration, while, in some other aspects, the anchor cell 602 may be associated with a different area ID than an area ID of the multi-cell UL-WUS configuration.

In some other aspects, the multi-cell UL-WUS configuration may be associated with a list of cells (e.g., a list of NES cells 604) for which the UL-WUS configuration applies. Put another way, in some aspects the UL-WUS configuration may indicate a list of cell IDs associated with the multiple cells (e.g., the first NES cell 604-1 through the N-th NES cell 604-N). For example, in aspects in which the UE 120 receives the multi-cell UL-WUS configuration from the anchor cell 602, the anchor cell may provide a list of cell IDs (e.g., IDs of the first NES cell 604-1 through the N-th NES cell 604-N) that are associated with multi-cell UL-WUS configuration.

In some other aspects, one or more zones may be defined that each comprise one or more cells (e.g., one or more NES cells 604) and/or one or more geographic locations. In such aspects, each NES cell 604 that is associated with a given multi-cell UL-WUS configuration may be associated with a same zone ID as the zone ID of the multi-cell UL-WUS configuration. In that regard, a cell (e.g., the anchor cell 602) may identify the zone ID for the multi-cell UL-WUS configuration, and the UE 120 may thereafter apply the multi-cell UL-WUS configuration for the corresponding zone. Put another way, in some aspects the UL-WUS configuration may indicate a zone ID, and each cell (e.g., each NES cell 604), of the multiple cells associated with the UL-WUS configuration (e.g., the first NES cell 604-1 through the N-th NES cell 604-N), may be associated with the same zone ID.

In some other aspects, the multi-cell UL-WUS configuration may be associated with one or more public land mobile network (PLMNs). In such aspects, the multi-cell UL-WUS configuration may indicate the PLMN ID (or, alternatively, a list of PLMN IDs) for which the multi-cell UL-WUS configuration applies. Similarly, in some other aspects, the multi-cell UL-WUS configuration may be associated with a tracking area ID and/or a RNA ID, which may be IDs used for purposes of tracking UEs for mobility handling at a core network, among other examples. In such aspects, the multi-cell UL-WUS configuration may indicate the tracking area ID (or, alternatively, a list of tracking area IDs) and/or RNA ID (or, alternatively, a list of RAN IDs) for which the multi-cell UL-WUS configuration applies.

In some aspects, the UE 120 may be statically configured or semistatically configured with multi-cell UL-WUS configuration information, and/or a given multi-cell UL-WUS configuration may be activated via a subsequent indication (e.g., a dynamic indication such as a MAC-CE, DCI, or the like), such as the indication described in more detail below in connection with reference number 608. For example, the UE 120 may be provided (e.g., from the network, a cloud-based service, and/or the like) with one or more multi-cell UL-WUS configurations, such as when the UE 120 establishes a connection with the anchor cell 602. In such aspects, each of the one or more multi-cell UL-WUS configurations may be associated with a corresponding ID (sometimes referred to herein as a configuration ID), which may correspond to the zone ID described above and/or which may function in a substantially similar manner as the zone ID described above. In such aspects, the anchor cell 602 may indicate (e.g., via a MAC-CE, DCI, and/or a similar communication) the configuration ID (e.g., the zone ID) for the nearby NES cells (e.g., the first NES cell 604-1 through the N-th NES cell 604-N), such that the UE 120 may retrieve (e.g., from a memory associated with the UE 120) the corresponding multi-cell UL-WUS configuration and/or transmit a UL-WUS (e.g., a request for an on-demand SIB1 to be transmitted) using the information associated with the corresponding multi-cell UL-WUS configuration, accordingly. Put another way, in some aspects, the UE 120 may receive (e.g., from the anchor cell 602 and/or a different cell) configuration information indicating a plurality of UL-WUS configurations, with each of the plurality of UL-WUS configurations being associated with a corresponding configuration ID, and thus the anchor cell 602 may subsequently transmit, and the UE 120 may receive, an indication of a configuration ID to indicate which multi-cell UL-WUS configuration is to be used for the nearby NES cells 604 (e.g., the first NES cell 604-1 through the N-th NES cell 604-N).

The UE 120 may configure itself based at least in part on the configuration information. In some aspects, the UE 120 may be configured to perform one or more operations described herein based at least in part on the configuration information.

In some aspects, the UE 120 may transmit, and the one or more network nodes (e.g., network nodes associated with the anchor cell 602 and/or the NES cells 604) may receive, a capabilities report. The capabilities report may indicate whether the UE 120 supports a feature and/or one or more parameters related to the feature. For example, the capability information may indicate a capability and/or parameter for transmitting a UL-WUS. One or more operations described herein may be based on capability information of the capabilities report. For example, the UE 120 may perform a communication in accordance with the capability information, or may receive configuration information (e.g., a multi-cell UL-WUS configuration) that is in accordance with the capability information. In some aspects, the capabilities report may indicate UE 120 support for receiving configuration information indicating a multi-cell UL-WUS configuration, validating a UL-WUS occasion associated with a cell covered by the multi-cell UL-WUS configuration, and/or transmitting a UL-WUS to the cell using the UL-WUS occasion based at least in part on validating the UL-WUS occasion, among other examples.

In some aspects, the configuration information described in connection with reference number 606 and/or the capabilities report may include information transmitted via multiple communications. Additionally, or alternatively, the one or more network nodes may transmit the configuration information, or a communication including at least a portion of the configuration information, before and/or after the UE 120 transmits the capabilities report. For example, the one or more network nodes may transmit a first portion of the configuration information before the capabilities report, the UE 120 may transmit at least a portion of the capabilities report, and the network node may transmit a second portion of the configuration information after receiving the capabilities report.

As shown by reference number 608, in some aspects the anchor cell 602 may transmit, and the UE 120 may receive, an indication of a configuration ID associated with a multi-cell UL-WUS configuration. More particularly, in aspects in which the UE 120 is statically or semistatically configurated with a plurality of multi-cell UL-WUS configurations, each associated with a corresponding configuration ID (e.g., zone ID), the anchor cell 602 may transmit, and the UE 120 may receive, an indication of a configuration ID that is associated with a multi-cell UL-WUS configuration to be used for the nearby NES cells 604 (e.g., the first NES cell 604-1 through the N-th NES cell 604-N). The indication may be transmitted via a MAC-CE, DCI, RRC signaling, and/or any other suitable communication. In such aspects, the UE 120 may identify a multi-cell UL-WUS configuration to be used for the nearby NES cells 604 based at least in part on the configuration ID. For example, the UE 120 may retrieve from a local memory the multi-cell UL-WUS configuration associated with the same configuration ID as the configuration ID indicated in the communications shown in connection with reference number 608.

In some aspects, prior to transmitting a UL-WUS (e.g., a request for SIB1) to a given one of the NES cells 604, the UE 120 may perform a validation procedure to ensure a given UL-WUS occasion associated with the UL-WUS configuration is a valid UL-WUS for the chosen cell. Put another way, in some aspects the UE 120 may identify a cell (e.g., one the first NES cell 604-1 through the N-th NES cell 604-N) to which a UL-WUS (e.g., a request for an on-demand SIB1) is to be transmitted, and/or the UE 120 may identify a valid UL-WUS occasion, of one or more UL-WUS occasions indicated by the multi-cell UL-WUS configuration, for transmitting the UL-WUS to the cell. In some aspects, a UL-WUS occasion may be a valid UL-WUS if the UL-WUS occasion does not collide with a downlink (DL) set of symbols (e.g., a set of TDD symbols semi-statically configured as DL symbols, sometimes referred to simply as “D” symbols), and/or if the UL-WUS occasion does not collide with an SSB set of symbols (e.g., a set of symbols in which the corresponding cell transmits an SSB).

Accordingly, in such aspects, in order to determine if a given UL-WUS occasion is a valid UL-WUS occasion for a certain cell, the UE 120 may need a list of SSBs transmitted by the cell, a TDD configuration associated with the cell, and/or similar information. In some aspects, a list of SSBs transmitted by the cell and/or a TDD configuration associated with the cell may be cell-specific or else may be applicable to a certain area and/or groups of cells. For example, in some aspects a TDD configuration may be cell-specific or else may be common across cells in a given area. Additionally, or alternatively, a list of SSBs transmitted by the cell may be cell-specific and/or may vary significantly from one cell (e.g., one of the first NES cell 604-1 through the N-th NES cell 604-N) to another cell (e.g., a different one of the first NES cell 604-1 through the N-th NES cell 604-N). In that regard, in aspects in which a common UL-WUS configuration is provided to the UE 120 for multiple cells (e.g., a UL-WUS configuration common to the first NES cell 604-1 through the N-th NES cell 604-N), other parameters and/or configurations (e.g., a TDD configuration, a list of transmitted SSBs, among other information), may be cell-specific and thus may affect whether a given UL-WUS occasion indicated by the multi-cell UL-WUS configuration is valid for a certain cell.

In that regard, in some aspects, one or more of the network nodes (e.g., the network nodes associated with the anchor cell 602 and/or the NES cells 604) may transmit, and the UE 120 may receive, TDD configuration information, SSB information (e.g., a list of SSBs transmitted by a cell), and/or similar information to be used for performing a UL-WUS occasion validation procedure. Moreover, as indicated by reference number 612, the UE 120 identify a valid UL-WUS occasion, of the one or more UL-WUS occasions indicated by the multi-cell UL-WUS configuration, for transmitting a UL-WUS to given cell (e.g., one of the first NES cell 604-1 through the N-th NES cell 604-N) based at least in part on the multi-cell UL-WUS configuration, the TDD configuration information, the SSB information, and/or similar information.

For example, in some aspects, a TDD configuration and/or a list of transmitted SSBs may be commonly configured for a group of cells (e.g., a group of NES cells 604), and thus the TDD configuration and/or the list of transmitted SSBs may be signaled to the UE 120 along with an identification of a group of cells for which the TDD configuration and/or the list of transmitted SSBs are applicable. Put another way, via the signaling shown in connection with reference number 610, the UE 120 may receive an indication of at least one of a TDD configuration associated with a group of cells or a list of transmitted SSBs for the group of cells, and thus, via the operations shown in connection with reference number 612, the UE 120 may identify the valid UL-WUS occasion for a given NES cell 604 based at least in part on the multi-cell UL-WUS configuration and the at least one of the TDD configuration for the group of cells or the list of transmitted SSBs for the group of cells. In some aspects, the group of cells associated with TDD configuration and/or the list of transmitted SSBs may be same group of cells that are associated with the multi-cell UL-WUS configuration, while, in some other aspects, the group of cells associated with TDD configuration and/or the list of transmitted SSBs may be a different group of cells than the group of cells that are associated with the multi-cell UL-WUS configuration. For example, in some aspects the multi-cell UL-WUS configuration may be PLMN-specific and the TDD configuration and/or the list of transmitted SSBs may be area-specific, among other examples.

In some other aspects, a cell (e.g., the anchor cell 602) may transmit to the UE 120 an indication of a TDD configuration and/or a list of transmitted SSBs individually for each NES cell 604. For example, via the communications shown in connection with reference number 610, the anchor cell 602 may transmit an indication of a first TDD configuration associated with the first NES cell 604-1 and/or a first list of transmitted SSBs associated with the first NES cell 604-1, an indication of a second TDD configuration associated with a second NES cell (not shown) and/or a second list of transmitted SSBs associated with the second NES cell, and so forth through an indication of an N-th TDD configuration associated with the N-th NES cell 604-N and/or an N-th list of transmitted SSBs associated with the N-th NES cell 604-N. Put another way, the UE 120 may receive, for each cell, of the multiple cells associated with the multi-cell UL-WUS configuration, an indication of a TDD configuration associated with that cell and/or a list of transmitted SSBs for that cell. In such aspects, via the operations shown in connection with reference number 612, the UE 120 may identify the valid UL-WUS occasion for a given NES cell 604 based at least in part on the multi-cell UL-WUS configuration and the TDD configuration for that cell or the list of transmitted SSBs for that cell.

In some other aspects, to identify the valid UL-WUS occasion for a given cell, the UE 120 may use a TDD configuration and/or a list of transmitted SSBs of the anchor cell 602. Put another way, in some aspects the UE 120 may assume that the TDD configuration of the NES cells 604 and/or the list of transmitted SSBs for the NES cells 604 are the same as those of the anchor cell 602. Accordingly, in order to validate the UL-WUS occasion, the UE 120 may identify at least one of a TDD configuration associated with the anchor cell 602 or a list of transmitted SSBs for the anchor cell 602, and thus identify the valid UL-WUS occasion based at least in part on the at least one of the anchor cell 602 TDD configuration or the anchor cell 602 list of transmitted SSBs.

Additionally, or alternatively, in some aspects, the UE 120 may assume that the TDD configuration and/or the list of transmitted SSBs for the NES cells 604 are the same as those of the anchor cell 602 for all NES cells 604 associated with a given multi-cell UL-WUS configuration, while, in some other aspects, the UE 120 may assume that the TDD configuration and/or the list of transmitted SSBs for the NES cells 604 are the same as those of the anchor cell 602 for only a subset of the NES cells 604 associated with the given multi-cell UL-WUS configuration. For example, in some aspects, the UE 120 may assume that the TDD configuration and/or the list of transmitted SSBs for the NES cells 604 are the same as those of the anchor cell 602 for only NES cells 604 that are within a same frequency range as the anchor cell 602 and/or for only NES cells 604 that are within a same frequency band as the anchor cell 602, among other examples.

In some other aspects, to identify the valid UL-WUS occasion for a given cell and/or for another purpose (e.g., SSB-to-beam mapping, among other examples), the UE 120 may assume all SSBs are being transmitted by the NES cell 604 to which the UL-WUS is to be transmitted. Put another way, in some aspects the UE 120 may identify a maximum quantity of potentially transmitted SSBs for a cell (e.g., an NES cell 604), and/or the UE 120 may identifying a valid UL-WUS occasion to be used to transmit a UL-WUS to the cell based at least in part on the maximum quantity of potentially transmitted SSBs. Alternatively, in some aspects, the UE 120 may assume all UL-WUS occasions are valid UL-WUS occasions. Put another way, in some aspects the UE 120 may be configured to identify that each UL-WUS occasion, of the one or more UL-WUS occasions indicated by the multi-cell UL-WUS configuration, is a valid UL-WUS occasion. In such aspects, the UE 120 may simply select any of the UL-WUS occasions as a valid UL-WUS occasion.

Based at least in part on the multi-cell UL-WUS configuration, TDD configuration information, SSB information, and/or similar information, the UE 120 may transmit a UL-WUS to one or more NES cells 604, such as for a purpose of requesting an on-demand SIB (e.g., SIB1) from the cells. For example, when a UL-WUS is to be transmitted to the first NES cell 604-1, the UE 120 may identify a valid UL-WUS occasion for the first NES cell 604-1 (indicated by reference number 614), such as by using the multi-cell UL-WUS configuration; a TDD configuration associated with a group of cells, the first NES cell 604-1, and/or the anchor cell 602; a list of transmitted SSBs associated with a group of cells, the first NES cell 604-1, and/or the anchor cell 602; and/or similar information, as described above in connection with reference numbers 610 and 612. Accordingly, as shown by reference number 616, the UE 120 may transmit, and a network node associated with the first NES cell 604-1 may receive, a UL-WUS using resources associated with the valid UL-WUS occasion indicated by reference number 614. In response, as shown in FIG. 6B and as indicated by reference number 618, the first NES cell 604-1 may transmit a responsive communication to the UE 120. For example, in some aspects, the first NES cell 604-1 may transmit, and the UE 120 may receive, a SIB (e.g., SIB1) (sometimes referred to herein as a triggered SIB1, because the SIB1 transmission was triggered by the UL-WUS) based at least in part on receiving the UL-WUS.

In some aspects, the UE 120 may transmit a UL-WUS to other NES cells 604 using the same multi-cell UL-WUS configuration as was used for transmitting the UL-WUS to the first NES cell 604-1. This is because the multi-cell UL-WUS configuration may be common to multiple NES cells 604, as described above in connection with reference numbers 606 and 608. In that regard, as indicated by reference number 620, when a UL-WUS is to be transmitted to the N-th NES cell 604-N, the UE 120 may identify a valid UL-WUS for transmitting the UL-WUS to the NES cell 604-N, which may be performed in a substantially similar manner as described above in connection with reference number 612. Accordingly, the UE 120 may identify a valid UL-WUS occasion for the N-th NES cell 604-N(indicated by reference number 622), such as by using the multi-cell UL-WUS configuration; a TDD configuration associated with a group of cells, the N-th NES cell 604-N, and/or the anchor cell 602; a list of transmitted SSBs associated with a group of cells, the N-th NES cell 604-N, and/or the anchor cell 602; and/or similar information. Accordingly, as shown by reference number 624, the UE 120 may transmit, and a network node associated with the N-th NES cell 604-N may receive, a UL-WUS using resources associated with the valid UL-WUS occasion indicated by reference number 622. In response, and as indicated by reference number 626, the N-th NES cell 604-N may transmit a responsive communication to the UE 120. For example, in some aspects, the N-th NES cell 604-N may transmit, and the UE 120 may receive, a SIB (e.g., a triggered SIB1) based at least in part on receiving the UL-WUS.

Based at least in part on one or more network nodes associated with one or more cells (e.g., the anchor cell 602 and/or one or more NES cell 604) configuring the UE 120 with a multi-cell UL-WUS configuration, the UE 120 and/or the network nodes may conserve computing, power, network, and/or communication resources that may have otherwise been consumed providing individual UL-WUS configurations for each NES cell 604. For example, based at least in part on one or more network nodes associated with one or more cells (e.g., the anchor cell 602 and/or one or more NES cell 604) configuring the UE 120 with a multi-cell UL-WUS configuration, the UE 120 and the network nodes may communicate with reduced signaling overhead and/or with reduced power consumption, which may result in more efficient usage of power, computing, and/or network resources.

As indicated above, FIGS. 6A-6B are provided as an example. Other examples may differ from what is described with respect to FIGS. 6A-6B.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with a multi-cell UL-WUS configuration.

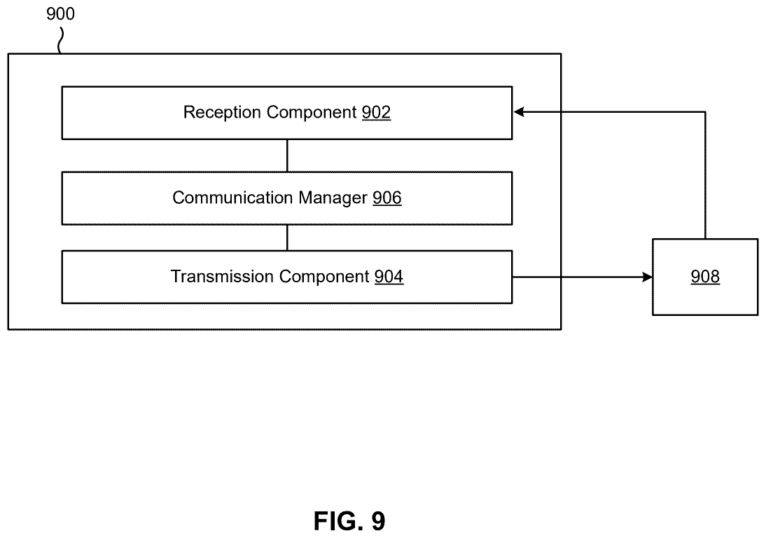

As shown in FIG. 7, in some aspects, process 700 may include receiving a UL-WUS configuration associated with multiple cells, wherein the UL-WUS configuration indicates resources associated with one or more UL-WUS occasions associated with the multiple cells (block 710). For example, the UE (e.g., using reception component 902 and/or communication manager 906, depicted in FIG. 9) may receive a UL-WUS configuration associated with multiple cells, wherein the UL-WUS configuration indicates resources associated with one or more UL-WUS occasions associated with the multiple cells, as described above.

As further shown in FIG. 7, in some aspects, process 700 may include identifying a cell, of the multiple cells, to which a UL-WUS is to be transmitted (block 720). For example, the UE (e.g., using communication manager 906, depicted in FIG. 9) may identify a cell, of the multiple cells, to which a UL-WUS is to be transmitted, as described above.

As further shown in FIG. 7, in some aspects, process 700 may include identifying a valid UL-WUS occasion, of the one or more UL-WUS occasions, for transmitting the UL-WUS to the cell based at least in part on the UL-WUS configuration (block 730). For example, the UE (e.g., using communication manager 906, depicted in FIG. 9) may identify a valid UL-WUS occasion, of the one or more UL-WUS occasions, for transmitting the UL-WUS to the cell based at least in part on the UL-WUS configuration, as described above.

As further shown in FIG. 7, in some aspects, process 700 may include transmitting, to the cell, the UL-WUS using resources associated with the valid UL-WUS occasion (block 740). For example, the UE (e.g., using transmission component 904 and/or communication manager 906, depicted in FIG. 9) may transmit, to the cell, the UL-WUS using resources associated with the valid UL-WUS occasion, as described above.

Process 700 may include additional aspects, such as any single aspect or any combination of aspects described below and/or in connection with one or more other processes described elsewhere herein.

In a first aspect, the UL-WUS configuration indicates an area identifier, and each cell, of the multiple cells, is associated with the area identifier.

In a second aspect, alone or in combination with the first aspect, receiving the UL-WUS configuration comprises receiving the UL-WUS configuration from an anchor cell, and the anchor cell is associated with the area identifier.

In a third aspect, alone or in combination with one or more of the first and second aspects, receiving the UL-WUS comprises receiving the UL-WUS from an anchor cell, and the anchor cell is not associated with the area identifier.

In a fourth aspect, alone or in combination with one or more of the first through third aspects, the UL-WUS configuration indicates a list of cell identifiers associated with the multiple cells.

In a fifth aspect, alone or in combination with one or more of the first through fourth aspects, the UL-WUS configuration indicates a zone identifier, and each cell, of the multiple cells, is associated with the zone identifier.

In a sixth aspect, alone or in combination with one or more of the first through fifth aspects, the UL-WUS configuration is associated with one or more public land mobile network identifiers.

In a seventh aspect, alone or in combination with one or more of the first through sixth aspects, the UL-WUS configuration is associated with at least one of a tracking area identifier or a radio access network notification area identifier.

In an eighth aspect, alone or in combination with one or more of the first through seventh aspects, the UL-WUS configuration is associated with one of a static configuration or a semistatic configuration.

In a ninth aspect, alone or in combination with one or more of the first through eighth aspects, receiving the UL-WUS configuration comprises receiving configuration information indicating a plurality of UL-WUS configurations including the UL-WUS configuration and one or more other UL-WUS configurations, wherein each of the plurality of UL-WUS configurations is associated with a corresponding configuration identifier, and process 700 further comprises receiving an indication of a configuration identifier associated with the UL-WUS configuration, and identifying the UL-WUS configuration based at least in part on the configuration identifier associated with the UL-WUS configuration.

In a tenth aspect, alone or in combination with one or more of the first through ninth aspects, process 700 includes receiving an indication of at least one of a TDD configuration associated with a group of cells or a list of transmitted SSBs for the group of cells, wherein identifying the valid UL-WUS occasion is further based at least in part on the at least one of the TDD configuration or the list of transmitted SSBs.

In an eleventh aspect, alone or in combination with one or more of the first through tenth aspects, the group of cells includes only the multiple cells.

In a twelfth aspect, alone or in combination with one or more of the first through eleventh aspects, the group of cells includes the cell and at least one other cell not associated with the multiple cells.

In a thirteenth aspect, alone or in combination with one or more of the first through twelfth aspects, process 700 includes receiving, for each cell, of the multiple cells, an indication of at least one of a TDD configuration associated with that cell or a list of transmitted SSBs for that cell, wherein identifying the valid UL-WUS occasion is further based at least in part on the at least one of the TDD configuration or the list of transmitted SSBs.

In a fourteenth aspect, alone or in combination with one or more of the first through thirteenth aspects, receiving the UL-WUS configuration comprises receiving the UL-WUS from an anchor cell, and process 700 further comprises identifying at least one of a TDD configuration associated with the anchor cell or a list of transmitted SSBs for the anchor cell, wherein identifying the valid UL-WUS occasion is further based at least in part on the at least one of the TDD configuration or the list of transmitted SSBs.

In a fifteenth aspect, alone or in combination with one or more of the first through fourteenth aspects, process 700 includes identifying a maximum quantity of potentially transmitted SSBs for the cell, wherein identifying the valid UL-WUS occasion is further based at least in part on the maximum quantity of potentially transmitted SSBs.

In a sixteenth aspect, alone or in combination with one or more of the first through fifteenth aspects, identifying the valid UL-WUS occasion includes identifying that each UL-WUS occasion, of the one or more UL-WUS occasions, is valid.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with a multi-cell UL-WUS configuration.

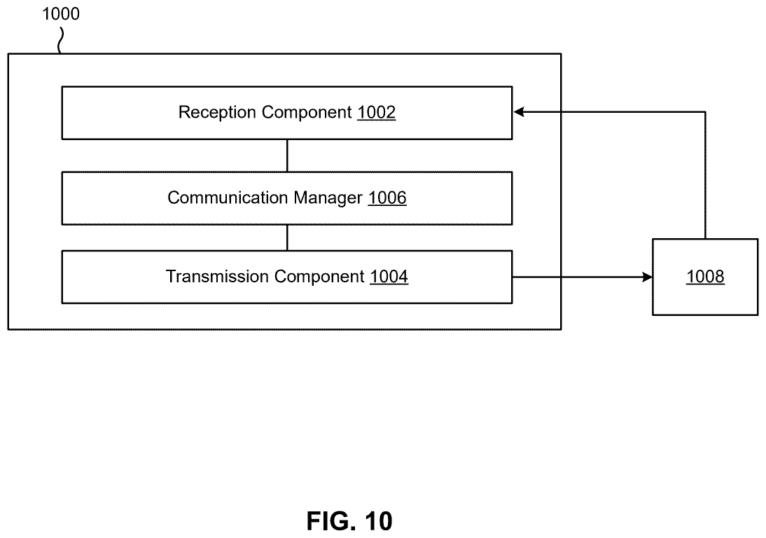

As shown in FIG. 8, in some aspects, process 800 may include receiving, from a UE and in resources associated with a valid UL-WUS occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node (block 810). For example, the network node (e.g., using reception component 1002 and/or communication manager 1006, depicted in FIG. 10) may receive, from a UE and in resources associated with a valid UL-WUS occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node, as described above.

As further shown in FIG. 8, in some aspects, process 800 may include transmitting, to the UE, a SIB based at least in part on receiving the UL-WUS (block 820). For example, the network node (e.g., using transmission component 1004 and/or communication manager 1006, depicted in FIG. 10) may transmit, to the UE, a SIB based at least in part on receiving the UL-WUS, as described above.

Process 800 may include additional aspects, such as any single aspect or any combination of aspects described below and/or in connection with one or more other processes described elsewhere herein.

In a first aspect, the UL-WUS configuration indicates an area identifier, and each cell, of the multiple cells, is associated with the area identifier.

In a second aspect, alone or in combination with the first aspect, the UL-WUS configuration is associated with an anchor cell, and the anchor cell is associated with the area identifier.

In a third aspect, alone or in combination with one or more of the first and second aspects, the UL-WUS configuration is associated with an anchor cell, and the anchor cell is not associated with the area identifier.

In a fourth aspect, alone or in combination with one or more of the first through third aspects, the UL-WUS configuration indicates a list of cell identifiers associated with the multiple cells.

In a fifth aspect, alone or in combination with one or more of the first through fourth aspects, the UL-WUS configuration indicates a zone identifier, and each cell, of the multiple cells, is associated with the zone identifier.

In a sixth aspect, alone or in combination with one or more of the first through fifth aspects, the UL-WUS configuration is associated with one or more public land mobile network identifiers.

In a seventh aspect, alone or in combination with one or more of the first through sixth aspects, the UL-WUS configuration is associated with at least one of a tracking area identifier or a radio access network notification area identifier.

In an eighth aspect, alone or in combination with one or more of the first through seventh aspects, the UL-WUS configuration is associated with one of a static configuration or a semistatic configuration.

In a ninth aspect, alone or in combination with one or more of the first through eighth aspects, the valid UL-WUS occasion is based at least in part on a TDD configuration associated with a group of cells or a list of transmitted SSBs for the group of cells, and the network node is associated with a cell included in the group of cells.

In a tenth aspect, alone or in combination with one or more of the first through ninth aspects, the group of cells includes only the multiple cells.

In an eleventh aspect, alone or in combination with one or more of the first through tenth aspects, the group of cells includes the cell and at least one other cell not associated with the multiple cells.

In a twelfth aspect, alone or in combination with one or more of the first through eleventh aspects, the valid UL-WUS occasion is based at least in part on a cell-specific TDD configuration associated with the network node or a cell-specific list of transmitted SSBs associated with the network node.

In a thirteenth aspect, alone or in combination with one or more of the first through twelfth aspects, the valid UL-WUS occasion is based at least in part on a TDD configuration associated with an anchor cell or a list of transmitted SSBs for the anchor cell.

In a fourteenth aspect, alone or in combination with one or more of the first through thirteenth aspects, the valid UL-WUS occasion is based at least in part on a maximum quantity of potentially transmitted SSBs for a cell associated with the network node.

In a fifteenth aspect, alone or in combination with one or more of the first through fourteenth aspects, the valid UL-WUS occasion is based at least in part on the valid UL-WUS occasion being indicated by the UL-WUS configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6A-6B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE 120 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE 120 described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE 120 described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a UL-WUS configuration associated with multiple cells, wherein the UL-WUS configuration indicates resources associated with one or more UL-WUS occasions associated with the multiple cells. The communication manager 906 may identify a cell, of the multiple cells, to which a UL-WUS is to be transmitted. The communication manager 906 may identify a valid UL-WUS occasion, of the one or more UL-WUS occasions, for transmitting the UL-WUS to the cell based at least in part on the UL-WUS configuration. The transmission component 904 may transmit, to the cell, the UL-WUS using resources associated with the valid UL-WUS occasion.

The reception component 902 may receive an indication of at least one of a TDD configuration associated with a group of cells or a list of transmitted SSBs for the group of cells, wherein identifying the valid UL-WUS occasion is further based at least in part on the at least one of the TDD configuration or the list of transmitted SSBs.

The reception component 902 may receive, for each cell, of the multiple cells, an indication of at least one of a TDD configuration associated with that cell or a list of transmitted SSBs for that cell, wherein identifying the valid UL-WUS occasion is further based at least in part on the at least one of the TDD configuration or the list of transmitted SSBs.

The communication manager 906 may identify a maximum quantity of potentially transmitted SSBs for the cell, wherein identifying the valid UL-WUS occasion is further based at least in part on the maximum quantity of potentially transmitted SSBs.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6A-6B. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node 110 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the network node 110 described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the network node 110 described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a UE and in resources associated with a valid UL-WUS occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node. The transmission component 1004 may transmit, to the UE, a SIB based at least in part on receiving the UL-WUS.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: receiving an uplink wakeup signal (UL-WUS) configuration associated with multiple cells, wherein the UL-WUS configuration indicates resources associated with one or more UL-WUS occasions associated with the multiple cells; identifying a cell, of the multiple cells, to which a UL-WUS is to be transmitted; identifying a valid UL-WUS occasion, of the one or more UL-WUS occasions, for transmitting the UL-WUS to the cell based at least in part on the UL-WUS configuration; and transmitting, to the cell, the UL-WUS using resources associated with the valid UL-WUS occasion.
Aspect 2: The method of Aspect 1, wherein the UL-WUS configuration indicates an area identifier, and wherein each cell, of the multiple cells, is associated with the area identifier.
Aspect 3: The method of Aspect 2, wherein receiving the UL-WUS configuration comprises receiving the UL-WUS configuration from an anchor cell, and wherein the anchor cell is associated with the area identifier.
Aspect 4: The method of Aspect 2, wherein receiving the UL-WUS comprises receiving the UL-WUS from an anchor cell, and wherein the anchor cell is not associated with the area identifier.
Aspect 5: The method of any of Aspects 1-4, wherein the UL-WUS configuration indicates a list of cell identifiers associated with the multiple cells.
Aspect 6: The method of any of Aspects 1-5, wherein the UL-WUS configuration indicates a zone identifier, and wherein each cell, of the multiple cells, is associated with the zone identifier.
Aspect 7: The method of any of Aspects 1-6, wherein the UL-WUS configuration is associated with one or more public land mobile network identifiers.
Aspect 8: The method of any of Aspects 1-7, wherein the UL-WUS configuration is associated with at least one of a tracking area identifier or a radio access network notification area identifier.
Aspect 9: The method of any of Aspects 1-8, wherein the UL-WUS configuration is associated with one of a static configuration or a semistatic configuration.
Aspect 10: The method of any of Aspects 1-9, wherein receiving the UL-WUS configuration comprises receiving configuration information indicating a plurality of UL-WUS configurations including the UL-WUS configuration and one or more other UL-WUS configurations, wherein each of the plurality of UL-WUS configurations is associated with a corresponding configuration identifier, and wherein the method further comprises: receiving an indication of a configuration identifier associated with the UL-WUS configuration; and identifying the UL-WUS configuration based at least in part on the configuration identifier associated with the UL-WUS configuration.
Aspect 11: The method of any of Aspects 1-10, further comprising receiving an indication of at least one of a time domain duplex (TDD) configuration associated with a group of cells or a list of transmitted synchronization signal blocks (SSBs) for the group of cells, wherein identifying the valid UL-WUS occasion is further based at least in part on the at least one of the TDD configuration or the list of transmitted SSBs.
Aspect 12: The method of Aspect 11, wherein the group of cells includes only the multiple cells.
Aspect 13: The method of Aspect 11, wherein the group of cells includes the cell and at least one other cell not associated with the multiple cells.
Aspect 14: The method of any of Aspects 1-13, further comprising receiving, for each cell, of the multiple cells, an indication of at least one of a time domain duplex (TDD) configuration associated with that cell or a list of transmitted synchronization signal blocks (SSBs) for that cell, wherein identifying the valid UL-WUS occasion is further based at least in part on the at least one of the TDD configuration or the list of transmitted SSBs.
Aspect 15: The method of any of Aspects 1-14, wherein receiving the UL-WUS configuration comprises receiving the UL-WUS from an anchor cell, and wherein the method further comprises: identifying at least one of a time domain duplex (TDD) configuration associated with the anchor cell or a list of transmitted synchronization signal blocks (SSBs) for the anchor cell, wherein identifying the valid UL-WUS occasion is further based at least in part on the at least one of the TDD configuration or the list of transmitted SSBs.
Aspect 16: The method of any of Aspects 1-15, further comprising identifying a maximum quantity of potentially transmitted synchronization signal blocks (SSBs) for the cell, wherein identifying the valid UL-WUS occasion is further based at least in part on the maximum quantity of potentially transmitted SSBs.
Aspect 17: The method of any of Aspects 1-16, wherein identifying the valid UL-WUS occasion includes identifying that each UL-WUS occasion, of the one or more UL-WUS occasions, is valid.
Aspect 18: A method of wireless communication performed by a network node, comprising: receiving, from a user equipment (UE) and in resources associated with a valid uplink wakeup signal (UL-WUS) occasion, a UL-WUS, wherein the valid UL-WUS occasion is associated with a UL-WUS configuration associated with multiple cells, wherein the UL-WUS configuration indicates resources associated with one or more UL-WUS occasions associated with the multiple cells, and wherein the valid UL-WUS occasion is a UL-WUS occasion, of the one or more UL-WUS occasions, that is associated with the network node; and transmitting, to the UE, a system information block (SIB) based at least in part on receiving the UL-WUS.
Aspect 19: The method of Aspect 18, wherein the UL-WUS configuration indicates an area identifier, and wherein each cell, of the multiple cells, is associated with the area identifier.
Aspect 20: The method of Aspect 19, wherein the UL-WUS configuration is associated with an anchor cell, and wherein the anchor cell is associated with the area identifier.
Aspect 21: The method of Aspect 19, wherein the UL-WUS configuration is associated with an anchor cell, and wherein the anchor cell is not associated with the area identifier.
Aspect 22: The method of any of Aspects 18-21, wherein the UL-WUS configuration indicates a list of cell identifiers associated with the multiple cells.
Aspect 23: The method of any of Aspects 18-22, wherein the UL-WUS configuration indicates a zone identifier, and wherein each cell, of the multiple cells, is associated with the zone identifier.
Aspect 24: The method of any of Aspects 18-23, wherein the UL-WUS configuration is associated with one or more public land mobile network identifiers.
Aspect 25: The method of any of Aspects 18-24, wherein the UL-WUS configuration is associated with at least one of a tracking area identifier or a radio access network notification area identifier.
Aspect 26: The method of any of Aspects 18-25, wherein the UL-WUS configuration is associated with one of a static configuration or a semistatic configuration.
Aspect 27: The method of any of Aspects 18-26, wherein the valid UL-WUS occasion is based at least in part on a time domain duplex (TDD) configuration associated with a group of cells or a list of transmitted synchronization signal blocks (SSBs) for the group of cells, and wherein the network node is associated with a cell included in the group of cells.
Aspect 28: The method of Aspect 27, wherein the group of cells includes only the multiple cells.
Aspect 29: The method of Aspect 27, wherein the group of cells includes the cell and at least one other cell not associated with the multiple cells.
Aspect 30: The method of any of Aspects 18-29, wherein the valid UL-WUS occasion is based at least in part on a cell-specific time domain duplex (TDD) configuration associated with the network node or a cell-specific list of transmitted synchronization signal blocks (SSBs) associated with the network node.
Aspect 31: The method of any of Aspects 18-30, wherein the valid UL-WUS occasion is based at least in part on a time domain duplex (TDD) configuration associated with an anchor cell or a list of transmitted synchronization signal blocks (SSBs) for the anchor cell.
Aspect 32: The method of any of Aspects 18-31, wherein the valid UL-WUS occasion is based at least in part on a maximum quantity of potentially transmitted synchronization signal blocks (SSBs) for a cell associated with the network node.
Aspect 33: The method of any of Aspects 18-32, wherein the valid UL-WUS occasion is based at least in part on the valid UL-WUS occasion being indicated by the UL-WUS configuration.
Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.
Aspect 35: An apparatus for wireless communication at a device, the apparatus comprising one or more memories and one or more processors coupled to the one or more memories, the one or more processors configured to cause the device to perform the method of one or more of Aspects 1-33.
Aspect 36: An apparatus for wireless communication, the apparatus comprising at least one means for performing the method of one or more of Aspects 1-33.
Aspect 37: A non-transitory computer-readable medium storing code for wireless communication, the code comprising instructions executable by one or more processors to perform the method of one or more of Aspects 1-33.
Aspect 38: A non-transitory computer-readable medium storing a set of instructions for wireless communication, the set of instructions comprising one or more instructions that, when executed by one or more processors of a device, cause the device to perform the method of one or more of Aspects 1-33.
Aspect 39: A device for wireless communication, the device comprising a processing system that includes one or more processors and one or more memories coupled with the one or more processors, the processing system configured to cause the device to perform the method of one or more of Aspects 1-33.
Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, which are configured, individually or in any combination, to:
receive an uplink wakeup signal (UL-WUS) configuration associated with multiple cells, wherein the UL-WUS configuration indicates resources associated with one or more UL-WUS occasions associated with the multiple cells;
identify a cell, of the multiple cells, to which a UL-WUS is to be transmitted;
identify a valid UL-WUS occasion, of the one or more UL-WUS occasions, for transmitting the UL-WUS to the cell based at least in part on the UL-WUS configuration; and
transmit, to the cell, the UL-WUS using resources associated with the valid UL-WUS occasion.

2. The UE of claim 1, wherein the UL-WUS configuration indicates an area identifier, and wherein each cell, of the multiple cells, is associated with the area identifier.

3. The UE of claim 2, wherein the one or more processors, to receive the UL-WUS configuration, are configured, individually or in any combination, to receive the UL-WUS configuration from an anchor cell, wherein the anchor cell is associated with the area identifier.

4. The UE of claim 2, wherein the one or more processors, to receive the UL-WUS, are configured, individually or in any combination, to receive the UL-WUS from an anchor cell, wherein the anchor cell is not associated with the area identifier.

5. The UE of claim 1, wherein the UL-WUS configuration indicates a list of cell identifiers associated with the multiple cells.

6. The UE of claim 1, wherein the UL-WUS configuration indicates a zone identifier, and wherein each cell, of the multiple cells, is associated with the zone identifier.

7. The UE of claim 1, wherein the UL-WUS configuration is associated with one or more public land mobile network identifiers.

8. The UE of claim 1, wherein the UL-WUS configuration is associated with at least one of a tracking area identifier or a radio access network notification area identifier.

9. The UE of claim 1, wherein the UL-WUS configuration is associated with one of a static configuration or a semistatic configuration.

10. The UE of claim 1, wherein the one or more processors, to receive the UL-WUS configuration, are configured, individually or in any combination, to receive configuration information indicating a plurality of UL-WUS configurations including the UL-WUS configuration and one or more other UL-WUS configurations,
wherein each of the plurality of UL-WUS configurations is associated with a corresponding configuration identifier, and
wherein the one or more processors are further configured, individually or in any combination, to:
receive an indication of a configuration identifier associated with the UL-WUS configuration; and
identify the UL-WUS configuration based at least in part on the configuration identifier associated with the UL-WUS configuration.

11. A method of wireless communication performed by a user equipment (UE), comprising:
receiving an uplink wakeup signal (UL-WUS) configuration associated with multiple cells, wherein the UL-WUS configuration indicates resources associated with one or more UL-WUS occasions associated with the multiple cells;
identifying a cell, of the multiple cells, to which a UL-WUS is to be transmitted;
identifying a valid UL-WUS occasion, of the one or more UL-WUS occasions, for transmitting the UL-WUS to the cell based at least in part on the UL-WUS configuration; and
transmitting, to the cell, the UL-WUS using resources associated with the valid UL-WUS occasion.

12. The method of claim 11, wherein the UL-WUS configuration indicates an area identifier, and wherein each cell, of the multiple cells, is associated with the area identifier.

13. The method of claim 12, wherein receiving the UL-WUS configuration comprises receiving the UL-WUS configuration from an anchor cell, and wherein the anchor cell is associated with the area identifier.

14. The method of claim 12, wherein receiving the UL-WUS comprises receiving the UL-WUS from an anchor cell, and wherein the anchor cell is not associated with the area identifier.

15. The method of claim 11, wherein the UL-WUS configuration indicates a list of cell identifiers associated with the multiple cells.

16. The method of claim 11, wherein the UL-WUS configuration indicates a zone identifier, and wherein each cell, of the multiple cells, is associated with the zone identifier.

17. The method of claim 11, wherein the UL-WUS configuration is associated with one or more public land mobile network identifiers.

18. The method of claim 11, wherein the UL-WUS configuration is associated with at least one of a tracking area identifier or a radio access network notification area identifier.

19. The method of claim 11, wherein the UL-WUS configuration is associated with one of a static configuration or a semistatic configuration.

20. The method of claim 11, wherein receiving the UL-WUS configuration comprises receiving configuration information indicating a plurality of UL-WUS configurations including the UL-WUS configuration and one or more other UL-WUS configurations,
wherein each of the plurality of UL-WUS configurations is associated with a corresponding configuration identifier, and
wherein the method further comprises:
receiving an indication of a configuration identifier associated with the UL-WUS configuration; and
identifying the UL-WUS configuration based at least in part on the configuration identifier associated with the UL-WUS configuration.
